(19) United States
(12) Patent Application Publication
(10) Pub. No.: US 2007/0047590 A1
(43) Pub. Date: Mar. 1, 2007

(54) Method for signaling a device to perform no synchronization or include a synchronization delay on multimedia stream

(75) Inventors: Igor Danilo Diego Curcio, Tampere (FI); Umesh Chandra, Allen, TX (US); David Leon, Irving, TX (US)

Correspondence Address: FOLEY & LARDNER LLP, P.O. BOX 80278, SAN DIEGO, CA, 92138-0278, US

(73) Assignee: Nokia Corporation

(21) Appl. No.: 11/213,330

(22) Filed: Aug. 26, 2005

(51) Int. Cl. H04J 3/06

(52) U.S. Cl. 370/503

(57) ABSTRACT

An improved system and method for permitting a transmitting electronic device to indicate explicitly which streams in a multimedia stream being transmitted should not be synchronized or should include a specified amount of synchronization jitter. The present invention aids the receiving device in understanding the stream characteristics. The present invention also allows the receiving device to make an informed decision as to whether an synchronization jitter value should be used when synchronizing two or more streams. For certain applications such as uni-directional video sharing or video PoC, the sending device of the stream can indicate that the receiving device doesn't perform any or limited synchronization for better media quality.

### FIELD OF THE INVENTION

The present invention relates generally to the field of IP multimedia communication. More particularly, the present invention relates to a signalling mechanism that is used in multimedia communication to instruct a receiving device not to perform synchronization or to include a synchronization jitter between different multimedia streams.

### BACKGROUND OF THE INVENTION

During an IP multimedia call set up, the sending device (i.e., the offerer or originator) of the call specifies session information. The session information comprises media and transport-related information. This session information is carried in protocol messages such as the Session Description Protocol (SDP). The SDP is carried in a high level signaling protocol such as Session Initiation Protocol (SIP), Real Time Streaming Protocol (RTSP), etc. The Third Generation Partnership Project (3GPP) has specified SIP as the choice of signaling protocol for multimedia session set up for the IP Multimedia Subsystem (IMS).

In the SDP, the sending device and receiving device can specify different directions for the media streams giving rise to different types of applications. For example, if the sending device wishes to set up a one way media session (meaning that it wants to send video and expects that the receiving device only receives this video), it specifies in the SDP this media stream as a=sendonly. The receiving device, when it receives this SDP message and if it wishes to participate in this session, can specify the stream as a=recvonly. For video telephony calls, the sending device and the receiving device both specify the media streams' directions as a=sendrecv.

Generally, in an IP multimedia call, there is a need to synchronize the different media types at the receiving device side. For example, in an audio/video IP call, lip synchronization needs to be performed at the receiving device side for a good user experience. Another example for synchronization involves the use of subtitles; if the sender of the audio and/or video is speaking in English and, if along with the speech, a text of the speech in a different language is sent in a different Real Time Transport Protocol (RTP) stream, then it is required that these two streams be synchronized at the receiving device.

Different media streams (from the sending device side) are carried in different RTP/User Data Protocol (UDP)/Internet Protocol (IP) streams. The RTP timestamps are used by the receiving device clients to perform inter-media synchronization.

FIG. 1 depicts a receiving device which receives multimedia streams from a sending device. The horizontal axis represents the elapsed time and shows packets being received. The audio and video buffer shown in FIG. 1 holds the RTP packets as it receives packets from the sending device. The buffer performs jitter removal (from the network) and calculates the playout time for each packet for each media. The decoding is performed once the packet has stayed in the buffer for a given period of time. This period of time is generally variable and part of this period of time is referred to as the jitter. Once the decoding is completed based on the playout time, the packets are provided for display or for playback. It should be noted that there can be two different buffers for holding the incoming RTP packets—one for jitter and one for the decoding queue. For clarity and exemplary purposes, only one queue is shown in FIG. 1, showing a combined jitter and decoding buffer. Once the packets are decoded, they are ready for playback or display once the playout time has elapsed. However, if the receiving device is trying to perform audio/video synchronization, it would attempt to delay the packets which have arrived first.

In the example shown in FIG. 1, audio packet 1 arrives at TA1, and the video packet arrives at TV1, which is later in time than TA1. It should be noted that the term “arrive” can refer to the time that the packets arrive or the playout time for each packet. In the example of FIG. 1, the audio and video packets with the same playback time need to be synchronized since they have the same reference clock capture time (at the sending device), meaning that they were sampled at the same time at the sending device. The calculation of the reference clock capture time is performed using the RTP time stamp in the RTP packet and the NTP time stamp, which is sent in the RTCP Sender Report (SR) packets. It is highly possible that the audio and video packets would arrive at the receiving device at different times, as they can take different network paths, and the processing delay (encoding, packetization, depacketization, decoding) for each packet can be different. Therefore, in the example shown in FIG. 1, the audio packets must be delayed for a time period of TV1-TA1, which is the synchronization jitter or delay.

In the example shown in FIG. 1, if the application (or sender) did not intend to perform A/V synchronization, but the receiving device nevertheless attempts to perform synchronization (as it is the default behavior), then the receiving device would be forced to hold the audio packets for additional time. This action can possibly overflow the audio buffer. Additionally, the audio packets at the head of the queue are delayed when synchronization is attempted, which can lead to a bad user experience or media quality. If Quality of Service (QoS) is guaranteed, then audio and video packets may have to be dropped in the event that they get delayed more in the queue. Therefore, even though the sending device may not want the media streams to be synchronized, problems such as packet loss, delayed packets, and the wasting of computational resources may occur due to the lack of a mechanism where the sending device could indicate to the receiving device that no synchronization or delayed synchronization is required.

In Request for Comments (RFC) No. 3388 from the Internet Engineering Task Force's Network Working Group, a mechanism is specified where the sending device can explicitly specify which media streams in the session need to be synchronized. New SDP attributes are defined (e.g., “group”, “mid” and Lip Synchronization (LS)) which can help the sending device specify which media streams in the session need to be lip synchronized. Also, the default implementation behavior of the RTP receiving device is to synchronize the media streams which it is receiving from the same source. Furthermore, the specification does not mandate that if one has to synchronize multimedia streams, then RFC 3388 is required. RFC 3388 only specifies a mechanism which can let the sending device specify which streams need to be synchronized if it is sending two or more streams.

There are applications and use cases where it is required that the multimedia streams should not be synchronized. For example, in Real Time Video Sharing (RTVS) applications, a user starts a uni-directional video sharing session. A uni-directional media session is set up by declaring the media stream in the SDP as a=sendonly or a=recvonly. There is already a bi-directional (or can be uni-directional) audio session set up between two parties. One of the parties in the call wishes to share video with the other party. The audio and the video are set up on the IP bearer, although it is possible that the audio or the video session can be set up on the circuit switched bearer as well. The shared video can be from a file or from a live camera view.

In some scenarios in unidirectional video sharing, the sending device does not want to synchronize the video (which is sharing from a file) and the speech. One reason for this desire not to synchronize could be that the sending device prefers that the video be received with high quality at the receiving device, even though it is delayed. In this situation, the sending device may prefer that the receiving device have a higher delay buffer and, therefore, does not want to perform synchronization.

Another uni-directional video sharing example involves where a user is taking video of some object and talking about it. In this situation, a coarser form of synchronization should be sufficient than a perfect synchronization, since the person is not taking video of his/her own face, but filming a different object. Yet another example involves “augmented reality,” where graphics are mixed with real-time audio and video. In this case, a coarser form of synchronization would suffice.

If the default behavior of the client were to synchronize these two streams, then the receiving device client would employ special algorithms to synchronize these streams. The synchronization algorithm at the receiving device side would require a specified amount of computational complexity, and the client would be wasting some resources, even when the sending device didn't prefer any synchronization. The audio and the video stream can arrive at the receiving device with different delays. If the receiving device tries to synchronize the streams, it may result in the dropping of the audio and video frames, thus reducing the quality of the received media.

Unfortunately, RFC 3388 does not discuss a mechanism where it can be clearly identified which streams should not be synchronized. For example, if a sending device wishes to send 3 streams, 2 Audio streams (A1, and A2) and 1 video stream (V1) in a session, and the sending device wishes to synchronize (lip synch) streams A1 and V1, it can specify it using the group, mid-SDP attributes and LS semantic tag. This would indicate to the receiving device that A1 and V1 need to be synchronized and A2 should not be synchronized. But for a use case where there are two or more streams and no streams need to be synchronized, then RFC 3388 falls short. Also, for indicating the performance of lip synchronization (and some cases where RFC 3388 can be used to specify no lip synchronization), RFC 3388 has to be mandated. Lastly, RFC 3388 does not offer a mechanism with which a device can indicate a desired synchronization jitter among different medias.

For the above reasons, there is currently no mechanism where the sending device can indicate to the receiving device in a multimedia call not to synchronize the multimedia stream that is being transmitted by the sending device, nor is there a mechanism to specify a synchronization delay or jitter for the multimedia stream.

### SUMMARY OF THE INVENTION

The present invention provides a mechanism whereby a transmitting or sending device can indicate explicitly which streams in the multimedia stream being sent should not be synchronized or should include a specified amount of synchronization jitter. This mechanism helps the receiving device understand the stream characteristics, and allows the receiving device to make an informed decision as to whether to perform synchronization or not, as well as to specify a synchronization jitter value. For certain applications such as unidirectional video sharing or video PoC, the sending device of the stream can indicate that the receiving device does not perform any synchronization for better media quality.

One embodiment of the present invention involves the introduction of a number of new SDP attributes. The sending device would declare these attributes in the SDP during the session set up phase, and the attributes can be carried in any higher level signalling protocol (e.g., SIP, RTSP, etc). However, these attributes are not restricted to the usage of the SDP protocol, and these attributes can be defined and carried using any other communication protocol at any of the layers 1-7 of the ISO OSI protocol stack (e.g., XML, HTTP, UPNP, CC/PP, etc.)

The present invention provides substantial benefits over the conventional RFC 3388 framework by providing the capability to indicate sending device preferences for no synchronization among media streams during the session set up phase. There are use cases and applications where the sending device does not desire the media it is transmitting to be synchronized. When this preference can be signaled to the receiving device, the receiving device can set up resources accordingly and does not have to waste computational resources, which can be used for other tasks or for better media quality. As a result, the present invention can result in fewer packet losses at the receiving device, which would occur if the receiving device attempts to perform media stream synchronization.

In addition to the above, the present invention improves upon RFC 3388 by providing the capability to indicate sending device preferences for synchronization jitter among media streams during the session set up phase. As there are also use cases and applications where the sending device desires that the media being transmitted should be synchronized with coarser jitter, the ability to signal this preference to the receiving device allows the receiving device to set up resources accordingly. This also provides the opportunity to conserve computational resources. In some cases, this can also yield an improved level of media quality. In fact, in a forced media synchronization scenario, there can be some packet losses, due to data discarding at the receiving device or other reasons, which would occur if the receiving device attempts to perform media stream synchronization. This is due to the fact that the media data can arrive at the receiving device with different delays, which may result in some content arriving too late to be useful for fully synchronized playback. By controlling the synchronization jitter, this issue can be alleviated or eliminated.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation showing the transmission of a plurality of audio and video packets from a sending device to a receiving device, where synchronization is performed by the receiving device even though synchronization is not required by the sending device.

FIG. 2 is a perspective view of an electronic device that can be used in the implementation of the present invention;

FIG. 3 is a schematic representation of the circuitry of the electronic device of FIG. 1; and

FIG. 4 is a flow chart showing the generic implementation of one embodiment of the present invention.

### DETAILED DESCRIPTION OF PREFERRED EMBODIMENTS

The present invention provides a mechanism whereby a transmitting or sending device can indicate explicitly which streams in the multimedia stream being sent should not be synchronized or should include a specified amount of synchronization jitter. This mechanism helps the receiving device understand the stream characteristics, and allows the receiving device to make an informed decision as to whether to perform synchronization or not, as well as to specify a synchronization jitter value.

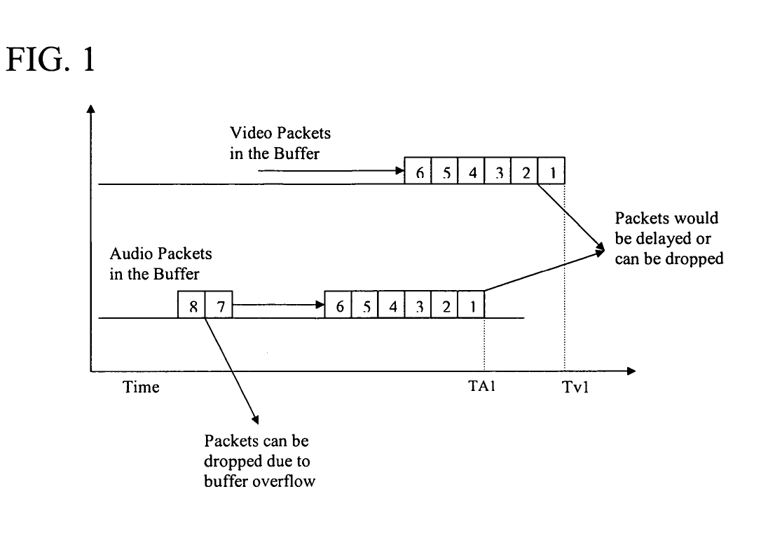

For understanding the implementation of the present invention, FIG. 1 can be used based upon the understanding that the sending device, during a session set up period, informs the receiving device that it does not want the receiving device to perform any synchronization or to perform synchronization with a coarser synchronization delay or jitter, using a specific value (500 msec, for example). In this scenario, the receiving device, when it has completed decoding and the play out time has passed for each packet of each media stream, can provide the respective packets for presentation. The receiving device does not have to delay the packets any longer than the specified value. This serves to prevent the jitter buffer overflow problem, the packets are not delayed for synchronization purposes, and the media quality is improved. In this scenario, the receiving must manage both media queue independently without any co-relation.

In the event that the sending device expects that the receiving device perform some synchronization with a specified delay value, then the receiving device, after decoding, determines the difference of the playout times for the audio and video packets (TV1-TA1). If this value is less than the value defined in the session set up for synchronization jitter, then the receiving device does not need to hold the audio and video packets for a longer period than what the playout time indicates. If the value (TV1-TA1) is more than the synchronization jitter, then the receiving device needs to hold the packets for a short period of time. For example, if the synchronization jitter as specified during session set up is 500 msec and TV1-TA1 is 350 msec, then the receiving device does not need to specify anything. However, if TV1-TA1 is 600 msec, then the audio packet must delayed in the queue for an additional 100 msec.

In a first embodiment of the present invention, two mechanisms are specified that permit the sending device of multimedia streams to indicate that multimedia streams should not be synchronized. This embodiment involves the introduction of new SDP parameters that aid the sending device of the multimedia streams in specifying that the receiving device should not perform synchronization.

In the first mechanism, a new SDP attribute called “NO_SYNC” is introduced. “NO_SYNC” indicates that the streams should not be synchronized with any other multimedia stream in the session. The NO_SYNC attribute is declared as a=NO_SYNC.

The NO_SYNC attribute can be defined at the media level (i.e., after the m line in SDP), or it can be defined at the session level. When defined at the media level, the NO_SYNC attribute means that the media stream should not be synchronized with any other streams in the session. An example using the NO_SYNC attribute is as follows.

v=0

o=NRC 289084412 2890841235 IN IP4 123.124.125.1

s=Demo

c=IN IP4 123.124.125.1

m=video 6001 RTP/AVP 98

a=rtpmap:98 MP4V-ES/90000

a=NO_SYNC

m=video 5001 RTP/AVP 99

a=rtpmap 99H2.63/90000

m=audio 6001 RTP/AVP 98

a=rtpmap:98 AMR

In the above example, the first video streams should not be synchronized at the receiving device. The receiving device client, when it receives this SDP, knows that the video stream (with MPEG4 codec) should not be synchronized with any other stream. The receiving device can choose to synchronize or not synchronize the remaining (audio and video) stream.

The NO_SYNC attribute can be declared at the start of the session, which implies that all the streams in the session should not be synchronized. This is depicted as follows.

v=0

o=NRC 289084412 2890841235 IN IP4 123.124.125.1

s=Demo

c=IN IP4 123.124.125.1

a=NO_SYNC

m=video 6001 RTP/AVP 98

a=rtpmap:98 MP4V-ES/90000

m=audio 6001 RTP/AVP 98

a=rtpmap:98 AMR

In the above example the sending device indicates to the receiving device that all of the streams in this session should not be synchronized.

In another implementation example, an extension to RFC 3388 can be defined. This extension can be used to specify which streams should not be synchronized. The following is an example from the conventional RFC 3388 system that exhibits how synchronization is indicated in SDP:

v=0

o=Laura 289083124 289083124 IN IP4 one.example.com

t=0 0

c=IN IP4 224.2.17.12/127

a=group:LS 1 2

m=audio 30000 RTP/AVP 0

a=mid: 1

m=video 30002 RTP/AVP 31

a=mid:2

m=audio 30004 RTP/AVP 0

i=This media stream contains the Spanish translation

a=mid:3

In the above example, streams with mid 1 and mid 2 are to be synchronized. This is indicated with the LS semantic tag in the group attribute. With the new implementation, however, a new semantic tag is used with the group attribute “NLS,” which has the semantics of no synchronization. The following example shows how an indication can be provided that the stream should not be synchronized with any other streams in the session:

v=0

o=Laura 289083124 289083124 IN IP4 one.example.com

t=0 0

c=IN IP4 224.2.17.12/127

a=group:NLS 1

m=audio 30000 RTP/AVP 0

a=mid: 1

m=video 30002 RTP/AVP 31

a=mid:2

m=audio 30004 RTP/AVP 0

i=This media stream contains the Spanish translation

a=mid:3

In the above example, the stream with MID 1 is not synchronized with any other stream in the session. RFC 3388 can therefore be extended with this new semantic tag, which aids the sending device in indicating that no synchronization is required for a media stream.

The semantic tag LS and NLS can be used in the same session description to describe which streams need to be synchronized and which streams should not be synchronized. For example, in the SDP example depicted below, stream 1 should not be synchronized with any other stream in the session and stream 2 and 3 should be synchronized. In this way the sending device can explicitly describe which streams should be synchronized and which streams should not be synchronized.

v=0

o=Laura 289083124 289083124 IN IP4 one.example.com

t=0 0

c=IN IP4 224.2.17.12/127

a=group:NLS 1

a=group:LS 2 3

m=audio 30000 RTP/AVP 0

a=mid:1

m=video 30002 RTP/AVP 31

a=mid:2

m=audio 30004 RTP/AVP 0

i=This media stream contains the Spanish translation

a=mid:3

In a second embodiment of the present invention, a mechanism is introduced that permits the sending device of a multimedia stream to indicate a synchronization delay or jitter value among the multimedia streams which it wishes the receiving device to synchronize. In this embodiment, new SDP parameters are used to specify the jitter value. With these SDP attributes, the sending device could also specify which streams in a given multimedia session should not be synchronized with any other stream in the same session.

In one particular implementation of this embodiment, a new SDP attribute called “sync_jitter” is defined. This attribute indicates the synchronization delay among the multimedia streams. The sync_jitter SDP attribute is specified in the time units (e.g., milliseconds) or any other suitable unit. A value of 0 for the sync_jitter means that no synchronization should be performed. The attribute is declared in SDP as:

a=sync_jitter:value//value is for example in milliseconds.

The sync_jitter SDP attribute can be used in conjunction with the group and mid attribute and LS semantic tag (as defined in RFC 3388). When used with this attribute, the sync_jitter specifies the acceptable synchronization jitter among the streams that need to be synchronized as specified in the LS semantic tag. The following is an example from RFC 3388 describing how synchronization is conventionally indicated in SDP:

v=0

o=Laura 289083124 289083124 IN IP4 one.example.com

t=0 0

c=IN IP4 224.2.17.12/127

a=group:LS 1 2

m=audio 30000 RTP/AVP 0

a=mid:1

m=video 30002 RTP/AVP 31

a=mid:2

m=audio 30004 RTP/AVP 0

i=This media stream contains the Spanish translation

a=mid:3

In the above example, streams with mid 1 and mid 2 are to be synchronized. This is indicated with the LS semantic tag in the group attribute. However, in this example, there is no way to indicate the desired synchronization jitter between streams with mid 1 and 2. Depending upon different applications (such as uni-directional video sharing or real time conversation video telephony) the synchronization value would be different.

The following example extends the above example with the sync_jitter attribute. If the above SDP description is used for a uni-directional video sharing application, and if a coarser form of synchronization would suffice for a particular situation, the sending device can use a value of 500 ms, for example, for the synchronization jitter between streams with mid 1 and mid 2. In such a situation, the SDP would be as follows:

v=0

o=Laura 289083124 289083124 IN IP4 one.example.com

t=0 0

c=IN IP4 224.2.17.12/127

a=group:LS 1 2

a=sync_jitter:500

m=audio 30000 RTP/AVP 0

a=mid:1

m=video 30002 RTP/AVP 31

a=mid:2

m=audio 30004 RTP/AVP 0

i=This media stream contains the Spanish translation

a=mid:3

The sync_jitter attribute can be used with a value of 0. A value of 0 essentially specifies that the sending device does not wish a particular media stream to be synchronized with any other stream in the given session. As discussed previously, the default implementation is to perform synchronization, and if the sending device SDP implementation does not support RFC 3388, the sending device can use the sync_jitter attribute with a value of 0 to indicate that it does not wish to synchronize a given stream in a session with any other stream. An SDP example where a sending device specifies the sync_jitter value with 0 is as follows:

v=0

o=NRC 289084412 2890841235 IN IP4 123.124.125.1

s=Demo

c=IN IP4 123.124.125.1

m=video 6001 RTP/AVP 98

a=rtpmap:98 MP4V-ES/90000

a=sync_jitter:0

m=video 5001 RTP/AVP 99

a=rtpmap 99H2.63/90000

m=audio 6001 RTP/AVP 98

a=rtpmap:98 AMR

In the above example, the sending device does not want the first video stream (with MPEG-4) to be synchronized with any other stream in the session. The receiving device can choose whether to synchronize the remaining two streams given in the session.

It should be noted that it is possible that a proper value other than 0 for the sync_jitter may need to be selected to indicate that no synchronization is required, as 0 would have different semantics.

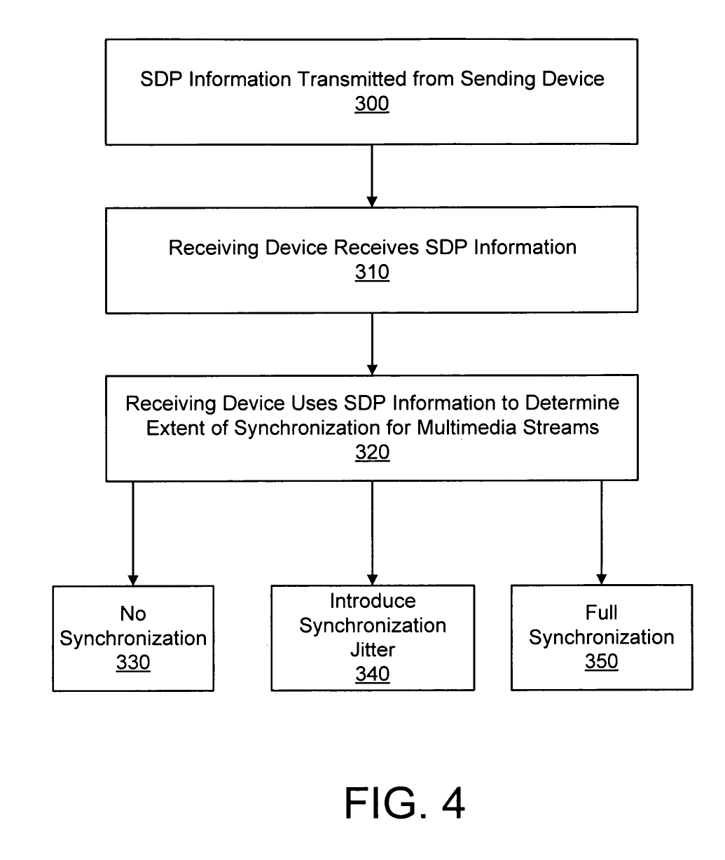

FIG. 4 is a generic flow chart showing the implementation of an embodiment of the present invention, where the sending device can designate either no synchronization or the introduction of a certain value of synchronization jitter. At step 300 in FIG. 4, the sending device transmits SDP information. The SDP information includes instructions of the types discussed above concerning the synchronization of the multimedia streams being transmitted. At step 310, the receiving device receives the SDP information. At step 320, the receiving device reads the SDP information to determine if there is an instruction not to synchronize any or all of the multimedia streams, whether to include a certain amount of synchronization jitter, or if full synchronization should occur. If there is an instruction for no synchronization, this instruction is followed at step 330. If there is a synchronization jitter value, then the designated amount of jitter is introduced into the stream at step 340. If there is no instruction regarding a lack of synchronization or an amount of synchronization jitter, or if there is a specific instruction for full synchronization, then full synchronization occurs at step 350.

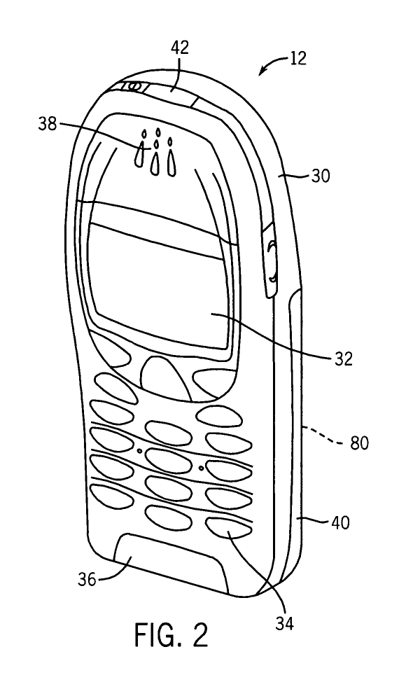

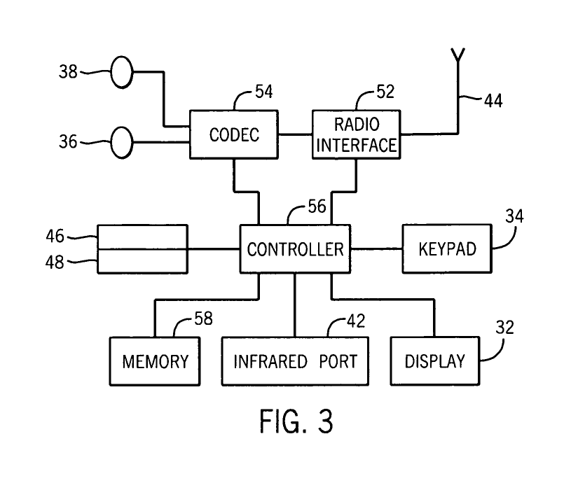

FIGS. 2 and 3 show one representative electronic device 12 within which the present invention may be implemented. The electronic device in FIGS. 2 and 3 comprises a mobile telephone and can be used as a sending device or a receiving device. It should be understood, however, that the present invention is not intended to be limited to one particular type of electronic device. For example, the electronic device 12 may comprise a personal digital assistant (PDA), combination PDA and mobile telephone, an integrated messaging device (IMD), a desktop computer, a notebook computer, or a variety of other devices.

The electronic device 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule-based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing synchronization information for a plurality of multimedia streams, comprising:
transmitting a plurality of multimedia streams to a receiving device; and
transmitting information regarding the plurality of multimedia streams, the information including a specific instruction for the receiving device to allow no synchronization or a specified amount of synchronization delay between at least one of the plurality of multimedia streams and at least one other of the plurality of multimedia streams.

2. The method of claim 1, wherein the instruction is included as an attribute in session information transmitted to the receiving device.

3. The method of claim 1, wherein the instruction includes an acceptable synchronization delay value between at least two of the multimedia streams.

4. The method of claim 1, wherein the instruction comprises a “sync_jitter” attribute.

5. The method of claim 4, wherein the “sync_jitter” attribute is accompanied by a value indicating no synchronization.

6. The method of claim 4, wherein the “sync_jitter” attribute is accompanied by an acceptable synchronization delay value.

7. The method of claim 4, wherein the “sync_jitter” attribute is an SDP attribute.

8. The method of claim 1, wherein the instruction comprises a “NO_SYNC” attribute.

9. The method of claim 1, wherein the instruction comprises a “NLS” semantic tag.

10. The method of claim 1, wherein the transmitted information instructs the receiving device not to synchronize any of the plurality of multimedia streams with each other.

11. The method of claim 1, wherein the transmitted information instructs the receiving device not to synchronize one of the plurality of multimedia streams with any of the other of the plurality of multimedia streams.

12. A computer program product providing synchronization information for a plurality of multimedia streams, comprising:
computer code for transmitting a plurality of multimedia streams to a receiving device; and
computer code for transmitting information regarding the plurality of multimedia streams, the information including a specific instruction for the receiving device to allow no synchronization or a specified amount of synchronization delay between at least one of the plurality of multimedia streams and at least one other of the plurality of multimedia streams.

13. The computer program product of claim 12, wherein the instruction is included as an attribute in session information transmitted to the receiving device.

14. The computer program product of claim 12, wherein the instruction includes an acceptable synchronization delay value between at least two of the multimedia streams.

15. The computer program product of claim 12, wherein the instruction comprises a “sync_jitter” attribute.

16. The computer program product of claim 15, wherein the “sync_jitter” attribute is accompanied by an acceptable synchronization delay value.

17. The computer program product of claim 15, wherein the “sync_jitter” attribute is an SDP attribute.

18. The computer program product of claim 12, wherein the transmitted information instructs the receiving device not to synchronize one of the plurality of multimedia streams with any of the other of the plurality of multimedia streams.

19. The computer program product of claim 12, wherein the transmitted information instructs the receiving device not to synchronize any of the plurality of multimedia streams with each other.

20. An electronic device, comprising:
a processor; and
a memory unit operatively connected to the processor and including:
computer code for transmitting a plurality of multimedia streams to a receiving device; and
computer code for transmitting information regarding the plurality of multimedia streams, the information including a specific instruction for the receiving device to allow no synchronization or a specified amount of synchronization delay between at least one of the plurality of multimedia streams and at least one other of the plurality of multimedia streams.

21. The electronic device of claim 20, wherein the instruction is included as an attribute in session information transmitted to the receiving device.

22. The electronic device of claim 20, wherein the instruction includes an acceptable synchronization delay value between at least two of the multimedia streams.

23. The electronic device of claim 20, wherein the instruction comprises a “sync_jitter” attribute.

24. The electronic device of claim 23, wherein the “sync_jitter” attribute is accompanied by an acceptable synchronization delay value.

25. The electronic device of claim 23, wherein the “sync_jitter” attribute is an SDP attribute.

26. The electronic device of claim 20, wherein the transmitted information instructs the receiving device not to synchronize any of the plurality of multimedia streams with each other.

27. The electronic device of claim 20, wherein the transmitted information instructs the receiving device not to synchronize one of the plurality of multimedia streams with any of the other of the plurality of multimedia streams.

28. The electronic device of claim 20, wherein the electric device comprises a device selected from the group consisting of a mobile telephone, a personal digital assistant, a laptop computer, a desktop computer, an integrated messaging device, and combinations thereof.

29. A method of processing multimedia content, comprising:
receiving a plurality of multimedia streams from a sending device;
receiving information regarding the plurality of multimedia streams from the sending device; and
if the received information includes a specific instruction to allow no synchronization or a specified amount of synchronization delay between at least one of the plurality of multimedia streams and at least one other of the plurality of multimedia streams, exhibiting the plurality of multimedia streams in accordance with the specific instruction.

30. The method of claim 29, wherein the instruction includes an acceptable synchronization delay value between at least two of the multimedia streams.

31. The method of claim 29, wherein the instruction comprises a “sync_jitter” attribute.

32. The method of claim 31, wherein the “sync_jitter” attribute is accompanied by an acceptable synchronization delay value.

33. The method of claim 29, wherein, in accordance with the received information, none of the plurality of multimedia streams are synchronized with each other.

34. The method of claim 29, wherein, in accordance with the received information, one of the plurality of multimedia streams is not synchronized with any of the other of the plurality of multimedia streams.

35. An electronic device, comprising:
a processor; and
a memory unit operatively connected to the processor and including:
means for transmitting a plurality of multimedia streams to a receiving device; and
means for transmitting information regarding the plurality of multimedia streams, the information including a specific instruction for the receiving device to allow no synchronization or a specified amount of synchronization delay between at least one of the plurality of multimedia streams and at least one other of the plurality of multimedia streams.
